(19) United States
(12) Patent Application Publication
(10) Pub. No.: US 2022/0161397 A1
(43) Pub. Date: May 26, 2022

(54) Track Spike Removal Adapter

(71) Applicants: Andrea Nicole Sanabria, San Antonio, TX (US); Alexandra Sanabria, San Antonio, TX (US)

(72) Inventors: Andrea Nicole Sanabria, San Antonio, TX (US); Alexandra Sanabria, San Antonio, TX (US)

(21) Appl. No.: 17/535,816

(22) Filed: Nov. 26, 2021

Related U.S. Application Data
(60) Provisional application No. 63/118,588, filed on Nov. 25, 2020.

(51) Int. Cl. B25B 13/50

(52) U.S. Cl. CPC B25B 13/50

(57) ABSTRACT

A track spike removal adapter is provided. The track spike removal adapter includes a body. The body has a first end and a second end. The first end has a wrench. The wrench has an opening that has a pair of parallel sides and a pair of curved sides. The opening, which is designed to receive a distal end of a track spike, extends into the body. The second end has a shank. The shank is designed to be engaged by a drill.

### CROSS REFERENCE TO RELATED APPLICATIONS

This application claims the benefit of U.S. Provisional Application No. 63/118,588 filed on Nov. 25, 2020. The above identified patent application is herein incorporated by reference in its entirety to provide continuity of disclosure.

### BACKGROUND OF THE INVENTION

The present invention relates to a removal tool for removing track spikes from the footwear on which it is attached. More specifically, the present invention provides a track spike wrench adapter configured to provide an faster, easier way to remove track spikes from athletic footwear.

When competing in track and field events, athletes generally will wear shoes that provide additional traction. By enhancing the ability of the athletic footwear to grip the track, or other surface, the athlete will be able to run faster. Generally, track shoes are characterized by soles with a plurality of apertures on the bottom surface thereof. The apertures are dimensioned to receive spikes therein. The spikes themselves generally have a threaded end designed to be secured within the aperture of the shoe and a pointed end that is disposed outside of the shoe. Depending on the specific events that the athlete is competing in, as well as the surface she or he is competing on, she or he may desire longer or shorter spikes.

Over the course of their use, track spikes will become dull and will no longer provide the user with the proper amount of traction necessary to compete effectively. When the track spikes cease to be sufficiently sharp, the athlete must replace them. Generally, track spikes are removed using a small plastic or metal device that encircles the track spike and is rotated by hand. This can be inconvenient, time consuming, and uncomfortable. During many track meets, time may be of the essence if the athlete must compete in different events occurring close together timewise. Additionally, as spikes dull, they can become more difficult to remove because it is harder for the small plastic or metal device to grip the spikes. Furthermore, the current methods of removing track spikes can result in lost, dropped, or misplaced track spikes. These can cause pain or discomfort if a track spike is stepped on or sat upon.

Additionally, the current devices utilized to remove track spikes are not compatible with any motorized or electric devices. By providing a track spike removal adapter that is compatible with a power drill, or similar device, athletes will be able to quickly and easily remove track spikes from their athletic footwear.

### SUMMARY OF THE INVENTION

In view of the foregoing disadvantages inherent in the known types of track spike removal methods and devices now present in the prior art, the present invention provides a track spike removal adapter wherein the same can be utilized for providing convenience for the user when removing spikes from athletic footwear.

The present system comprises a body. The body comprises a first end disposed opposite a second end. A wrench is disposed on the first end of the body. The wrench comprises an opening with a pair of elongated parallel sides and a pair of opposing curved sides. The opening extends into the body. A shank is disposed on the second end of the body. The shank is dimensioned to be attached to a drill.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the track spike removal adapter.

FIG. 2 shows a perspective view of a second embodiment of the track spike removal adapter.

FIG. 3 shows a demonstrative view of the track spike removal adapter.

### DETAILED DESCRIPTION OF THE INVENTION

Reference is made herein to the attached drawings. Like reference numerals are used throughout the drawings to depict like or similar elements of the track spike removal adapter. The figures are intended for representative purposes only and should not be considered to be limiting in any respect.

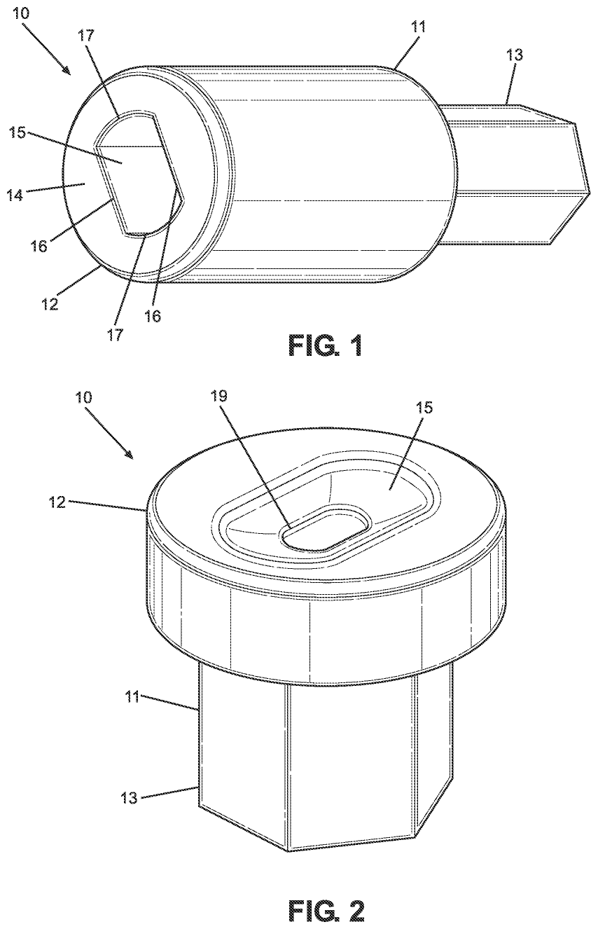

Referring now to FIG. 1, there is shown a perspective view of a first embodiment of the track spike removal adapter. The track spike removal adapter 10 comprises a body 11. The body 11 comprises a first end 12 disposed opposite a second end 13. The body 11 is ideally made of a durable material, such as steel or a hardened metal. In order to maintain its character as tension is applied to the various components of the track spike removal adapter 10, the track spike removal adapter must be made of a material of a requisite level of hardness such as to be rigid and nonpliable.

A wrench 14 is defined on the first end 12 of the body 11. The wrench 14 comprises an opening 15. The opening 15 is defined by a pair of elongated parallel sides 16 with a pair of curved sides 17 disposed between them. The pair of elongated parallel sides 16 are designed to apply torque to the flattened opposing portions generally present on most types of track spikes. The opening 15 extends into the body 11, such that a spike can be engaged by the track spike removal adapter 10. As such, the opening 15 must be of a sufficient depth to receive the track spike.

A shank 18 is disposed on the second end 13 of the body 11. The shank 18 is dimensioned to be received into the chuck of a drill. The shank 18 may be of any suitable configuration for being engaged by a power tool. For example, in the illustrated embodiment, the shank 18 is of a hexagonal cross-section such as to be received into a three-pronged drill chuck. However, in alternate embodiments, the shank 18 may be of a different cross-section.

In the illustrated embodiment, the portion of the body 11 corresponding to the wrench 14 is of a greater perimeter than the portion of the body 11 corresponding to the shank 18. As such, the torque applied to the shaft 18 will be dispersed among the larger perimeter of the wrench 14 as a reduced force. Furthermore, in the illustrated embodiment, the portion of the body 11 corresponding to the wrench 14 is of a greater length than the portion of the body 11 corresponding to the shank 18. As such, the wrench 14 will be able to accommodate a spike of a relatively longer length within the opening 15 of the wrench 14.

Referring now to FIG. 2, there is shown a perspective view of a second embodiment of the track spike removal adapter. In the illustrated embodiment, the portion of the body 11 corresponding to the wrench 14 is of a lesser length than the portion of the body corresponding to the shank 18. As such, the wrench 14 will be easier to move and manipulate. When removing and replacing track spikes on some kinds of athletic footwear, having a wrench 14 of a smaller surface area and a lower profile may be desired. Furthermore, in the illustrated embodiment, a secondary cavity 19 is defined within the opening 15. As such, even with a smaller wrench 14 additional depth may be provided to receive the track spike.

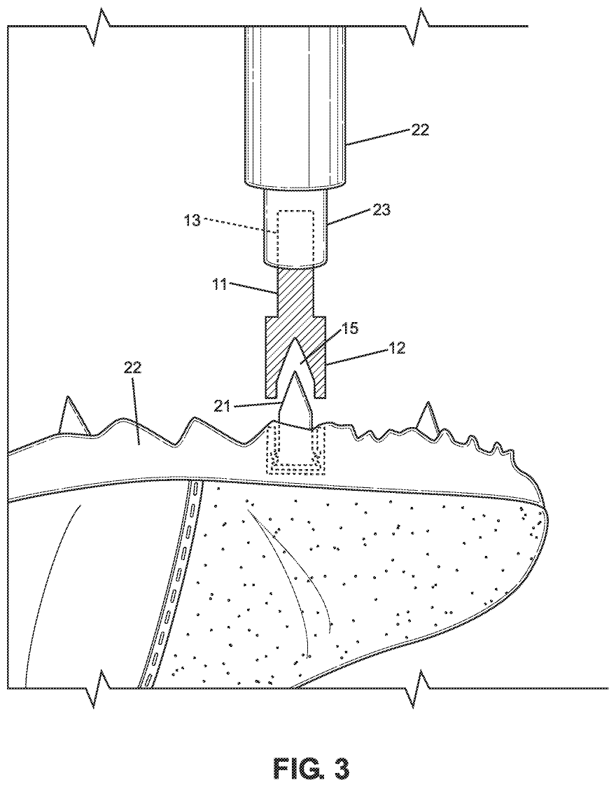

Referring now to FIG. 3, there is shown a demonstrative view of the track spike removal adapter. In use, the track spike removal tool is utilized to remove and replace track spikes 21 from athletic footwear 20. First, the track spike removal tool is attached to a drill 22 by inserting the shank 18 at the second end 13 of the body 11 into the chuck 23 of the drill 22. Once secured, actuating the drill 22 will spin the chuck 23 and thereby spin the track spike removal tool. The opening 15 at the first end 12 of the body 11 is engaged with a track spike 21 disposed in the sole of the athletic footwear. As such, when the track spike removal is rotated by the drill 22, it will either tighten or loosen the track spike 21 depending on the direction that the drill 22 is rotating the chuck 23.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A track spike removal adapter, comprising:
a body;
the body comprising a first end disposed opposite a second end;
a wrench disposed on the first end of the body;
the wrench comprising an opening with a pair of elongated parallel sides and a pair of opposing curved sides;
the opening extending into the body;
a shank disposed on the second end of the body;
the shank dimensioned to be attached to a drill.

2) The track spike removal adapter of claim 1, wherein the body is adjustable in length.

3) The track spike removal adapter of claim 1, wherein a first portion of the body corresponding to the wrench is of a lesser perimeter than a second portion of the body corresponding to the shank.

4) The track spike removal adapter of claim 1, wherein a first portion of the body corresponding to the wrench is of a lesser length than a second portion of the body corresponding to the shank.

5) The track spike removal adapter of claim 1, wherein a first portion of the body corresponding to the wrench is of a greater length than a second portion of the body corresponding to the shank.

6) The track spike removal adapter of claim 1, wherein a perimeter edge of the wrench is beveled.

7) The track spike removal adapter of claim 1, wherein the chuck is of a hexagonal cross-section.
